(19) United States
(12) Patent Application Publication
(10) Pub. No.: US 2007/0046463 A1
(43) Pub. Date: Mar. 1, 2007

(54) Portable computer and security method thereof

(76) Inventor: Hsin-Feng Tsai, Pao Chiao City (TW)

Correspondence Address: RABIN & Berdo, PC, 1101 14TH STREET, NW, SUITE 500, WASHINGTON, DC, 20005, US

(21) Appl. No.: 11/349,929

(22) Filed: Feb. 9, 2006

(30) Foreign Application Priority Data
Aug. 26, 2005 (TW) 94129358

(51) Int. Cl. G08B 13/14

(52) U.S. Cl. 340/568.1

(57) ABSTRACT

A portable computer includes a detection unit, a control unit and a warning unit. The detection unit is for detecting a force-exerted state of the portable computer and outputting a detection signal accordingly. The control unit is coupled to the detection unit for receiving the detection signal. The warning unit is coupled to the control unit for producing an alarm signal. When the portable computer is vibrated or shaken under a security mode, the control unit informs the warning unit to produce the alarm signal according to the detection signal.

This application claims the benefit of Taiwan application Serial No. 94129358, filed Aug. 26, 2005, the subject matter of which is incorporated herein by reference.

### BACKGROUND OF THE INVENTION

1. Field of the Invention

The invention relates in general to a portable computer and security method thereof, and more particularly to a portable computer which can automatically produce an alarm noise, enter a screen-saver operation, or inform the computer owner in a wireless way when the computer system is in a vibration or shaking state, and security method thereof.

2. Description of the Related Art

Along with technology progress, portable computers, such as notebook or tablet computers, are becoming a new trend in computer development due to the features of smallness, thinness and carriage convenience.

However, when people use the portable computer in a public place, important data of the computer or even the entire computer is easily stolen by burglars due to the owners' neglect.

Therefore, in order to improve security of the portable computer, the user usually sets the computer in a screen-saver operation as he or she leaves the computer, thereby preventing other people from entering the computer system and reading or stealing the data therein without permission.

Although this security mechanism can prevent the computer system from illegal invasion, it still cannot effectively frighten the burglar and even cannot prevent the burglar from stealing the computer, thereby causing a serious damage of the computer owner.

### SUMMARY OF THE INVENTION

It is therefore an object of the invention to provide a portable computer and security method thereof. Once the computer system is in a vibration or shaking state, the portable computer automatically produces an alarm noise to frighten the burglar, immediately enters the screen-saver operation, and informs the computer owner in a wireless way, thereby effectively reducing the risk of losing the portable computer and the interior data.

The invention achieves the above-identified object by providing a portable computer including a detection unit, a control unit and a warning unit. The detection unit is for detecting a force-exerted state of the portable computer and outputting a detection signal accordingly. The control unit is coupled to the detection unit for receiving the detection signal. The warning unit is coupled to the control unit for producing an alarm signal. When the portable computer is vibrated or shaken under a security mode, the control unit informs the warning unit to produce the alarm signal according to the detection signal.

The invention achieves the above-identified object by providing a security method for protecting a portable computer. The method includes setting the portable computer in a predetermined security mode; and producing an alarm signal when the portable computer is in a vibration or shaking state.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a block diagram of the portable computer according to a preferred embodiment of the invention.

FIG. 2 is a flow chart of a security method for protecting the portable computer according to the preferred embodiment of the invention.

FIG. 3 is a flow chart of the security operation of the portable computer in a software layer.

### DETAILED DESCRIPTION OF THE INVENTION

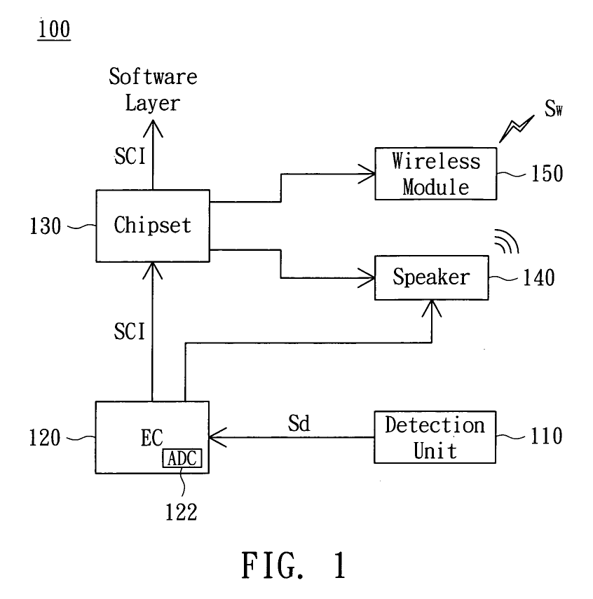

Referring to FIG. 1, a block diagram of the portable computer according to a preferred embodiment of the invention is shown. The portable computer 100, such as a notebook or tablet computer, includes a detection unit 110, an embedded controller (EC) 120, a chipset 130, a speaker 140, and a wireless module 150. The detection unit 110, such as an accelerometer, is used for detecting a force-exerted state of the portable computer 100, for example, the strength of the force causing the portable computer 100 to vibrate, shake or move, and outputting a detection signal Sd accordingly. The embedded controller 120, set in an always-on state, is coupled to the detection unit 110 for receiving the detection signal Sd, and triggering out a system control interrupt (SCI) signal accordingly. The chipset 130, such as a south-bridge chipset, is coupled to the embedded controller 120, the speaker 140 and the wireless module 150, for receiving the SCI signal and controlling the speaker 140 and the wireless module 150 according to the SCI signal. The wireless module 150 is, for example, a GPRS/GSM/GPS wireless module.

When the portable computer 100 is vibrated or shaken under a predetermined security mode, the chipset 130 controls the speaker 140 to produce an alarm noise to frighten the burglar according to the SCI signal triggered by the detection signal Sd, or controls the wireless module 150 to produce an alarm information Sw to inform the computer owner about the present state of the portable computer 100. Or the software layer of the portable computer 100 sets the portable computer 100 to enter the screen-saver operation immediately according to the triggered SCI signal to prevent the interior data of the portable computer from being stolen.

As shown in FIG. 1, if the detection unit 110 is an analog device, such as an analog accelerometer, the outputted detection signal Sd is an analog signal and thus the embedded controller 120 requires an embedded analog/digital converter (ADC) 122 to receive the analog detection signal Sd and convert the signal Sd into a digital signal capable of being received and processed by the computer. Of course, the analog detection signal Sd can also be converted into the digital signal via an exterior ADC (not shown in the figure) before being inputted to the embedded controller 120. The detection unit 110 can be a digital device and output a digital detection signal Sd, thus the embedded controller 120 can directly process the digital detection signal Sd.

Furthermore, the embedded controller 120 is coupled to the speaker 140. When the portable computer 100 is under a power-off security mode, the embedded controller 120 controls the speaker 140 to produce an alarm noise to achieve the purpose of warning the computer owner and frightening the burglar directly according to the detection signal Sd.

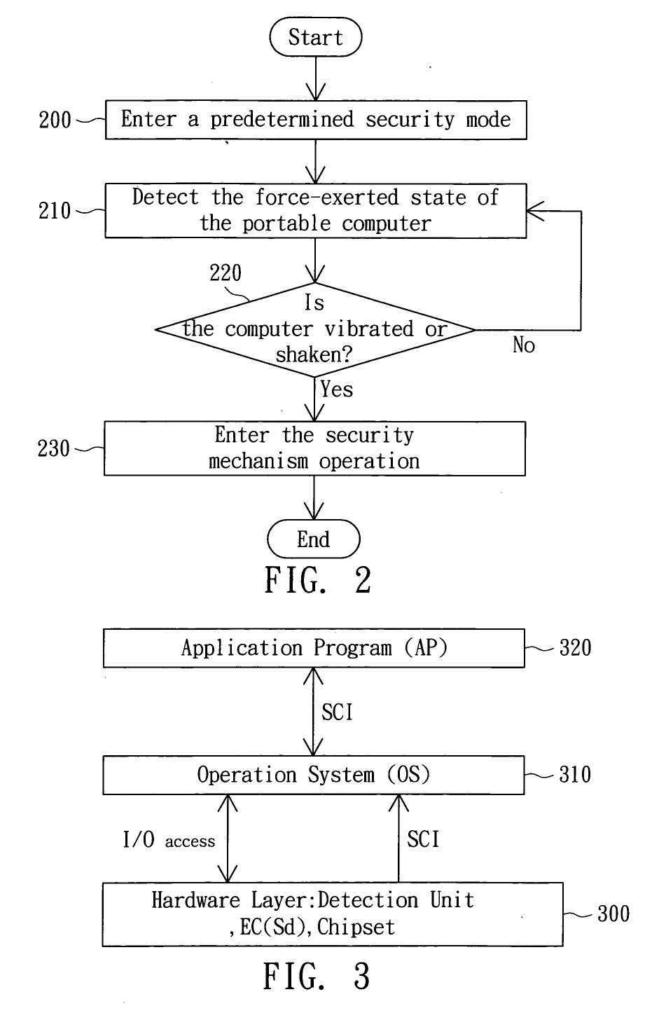

Referring to FIG. 2, a flow chart of a security method for protecting the portable computer according to the preferred embodiment of the invention is shown. First, in step 200, set the portable computer 100 in a predetermined power-on or power-off security mode when the computer user finishes using the computer or has to leave the computer temporarily. Following that, in step 210, detect the force-exerted state of the portable computer 100, such as the strength of force vibrating, shaking or moving the portable computer 100, by using the detection unit 110, such as an accelerometer, and provide a detection signal Sd accordingly.

Afterwards, in step 220, determine if the portable computer 100 is in a vibration or shaking state, that is, determine if the force-exerted state of the portable computer 100 is changed from a static state to a vibration or shaking state, according to the detection signal Sd. Referring to FIG. 3, a flow chart of the security operation of the portable computer in a software layer is shown. The embedded controller 120 located in the hardware layer 300 triggers out a SCI signal according to the detection signal Sd of the detection unit 110, and the SCI signal is transmitted to an operation system (OS) 310 of the portable computer 100. The OS 310 further transmits the SCI signal to an application program (AP) 320 of the portable computer 100 to inform that the embedded controller 120 has been triggered. After that, the OS 310 continuously transmits the SCI signals outputted by the embedded controller 120 to the AP 320 and the AP 320 determines if the portable computer is in a vibration or shaking state according to the content of the triggered SCI signal.

If the portable computer 100 is not in a vibration or shaking state, progress to the above-mentioned step 210 and go on detecting the force-exerted state of the portable computer 100. If the portable computer 100 is in a vibration or shaking state according to the determination of the AP 320, progress to the step 230 of FIG. 2 and enter a security mechanism operation. As shown in FIG. 3, when the AP 320 determines that the portable computer 100 is in a vibration or shaking state, the AP 320 will directly set or inform the hardware layer 300 via an I/O access by using the OS 310 to perform the predetermined security mechanism operation.

In the first security mechanism, the chipset 130 is informed to control the speaker 140 to produce an alarm noise or music. The purpose of this security mechanism is to frighten the burglar. The detection unit 110 having a high sensitivity can be used to detect any slight touch or vibration to improve the protection effect.

In the second security mechanism, the chipset 130 is informed to control the wireless module to produce an alarm information Sw. The purpose of this security mechanism is to immediately deliver warning information to the computer owner at a remote place. The alarm information Sw includes the information ‘the computer is under a vibration or shaking state’ and the location of the computer. By doing this, the risk of losing the computer or the interior data can be reduced. The GPS function of the wireless module 150 can be used to position the portable computer 100 while the GPRS/GSM function is for sending out a wireless signal to inform the computer owner.

In the third security mechanism, the AP 320 is used to directly lock up the computer system. The purpose of this security mechanism is to prevent other people from reading and accessing the computer data without permission. When the detection unit 110 detects that the computer 100 is being vibrated or shaken, the computer 100 is set to enter the screen-saver operation or display a predetermined protection picture in the meanwhile the security and secrecy of the computer data is enhanced by further requesting a password of the user.

In addition, if the portable computer 100 is under a power-off security mode, as mentioned above, the AP 320 informs the embedded controller 120 in the hardware layer 300 via the OS 310 to control the speaker 140 to produce the alarm noise or music, thereby achieving the purpose of frightening the burglar. If the portable computer 100 is under a power-on security mode, the AP 320 can perform the above-mentioned three security mechanisms of producing an alarm noise, producing alarm information and locking the system, or any combination of these security mechanisms to achieve the purpose of timely frightening the burglar and protecting the computer.

As mentioned above, although the embedded controller 120 is exemplified to receive the detection signal Sd and the speaker 140 or the wireless module 150 is controlled by the chipset 130 for illustration in the invention, the portable computer 100 of the invention can also use any other control unit to receive the detection signal Sd and control the speaker 140 or the wireless module 150 to produce the alarm noise or information accordingly. When the computer is in a vibration or shaking state under the security mode, the alarm signal can be timely produced to achieve the purpose of informing the computer owner or frightening the burglar. Therefore, it will not depart from the scope of the invention.

Besides, although the speaker 140 and the wireless module 150 are exemplified to give the alarm signals in the invention, the portable computer 100 of the invention can use any other warning unit controlled by the chipset 130 to produce the alarm signal when the computer is in a vibration or shaking state. As long as the warning unit can immediately inform the computer owner or frighten the burglar, thereby reducing the risk of losing the computer or the interior data, it will also fall in the scope of the invention.

According to the embodiment disclosed above, the portable computer and security method thereof of the invention has the following advantages:

1. When the system is in a vibration or shaking state, the alarm noise is produced automatically to frighten the burglar. Therefore, the risk of losing the computer or the interior data can be reduced.

2. After the system is vibrated or shaken, the system is locked by entering the screen-saver operation. Therefore, the security and secrecy of the computer data can be enhanced.

3. When the system is in a vibration or shaking state, a wireless signal is produced to inform the computer owner to return the place where the computer is located originally. Therefore, the stealing or breaking behavior of the burglar can be timely stopped and the security and secrecy of the portable computer and the interior data can be thus improved.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A portable computer, comprising:
a detection unit, for detecting a force-exerted state of the portable computer and outputting a detection signal accordingly;
a control unit, coupled to the detection unit, for receiving the detection signal; and
a warning unit, coupled to the control unit, for producing an alarm signal;
wherein when the portable computer is vibrated or shaken under a security mode, the control unit informs the warning unit to produce the alarm signal according to the detection signal.

2. The portable computer according to claim 1, wherein the control unit further comprises:
an embedded controller (EC), coupled to the detection unit, for receiving the detection signal, and outputting a system control interrupt (SCI) signal accordingly; and
a chipset, coupled to the embedded controller and the warning unit, for receiving the SCI signal, and controlling the warning unit according to the SCI signal.

3. The portable computer according to claim 2, wherein the detection signal is an analog signal and the embedded controller comprises an analog/digital converter for converting the detection signal into a digital signal.

4. The portable computer according to claim 2, wherein the embedded controller is coupled to the warning unit for controlling the warning unit according to the detection signal as the portable computer is set in a power-off state.

5. The portable computer according to claim 2, wherein when the portable computer is vibrated or shaken under the security mode, an application program of the portable computer sets the portable computer in a screen-saver operation according to the SCI signal of the chipset.

6. The portable computer according to claim 2, wherein the chipset is a south-bridge chipset.

7. The portable computer according to claim 1, wherein the detection unit is an accelerometer.

8. The portable computer according to claim 1, wherein the warning unit comprises a speaker and the alarm signal comprises an alarm noise.

9. The portable computer according to claim 1, wherein the warning unit comprises a wireless module and the alarm signal comprises an alarm information for informing the owner of the portable computer.

10. The portable computer according to claim 9, wherein the alarm information comprises the information that the portable computer is under a vibration or shaking state and the location of the portable computer.

11. The portable computer according to claim 1, is a notebook computer.

12. The portable computer according to claim 1, is a tablet computer.

13. A security method for protecting a portable computer, comprising:
setting the portable computer in a predetermined security mode; and
producing an alarm signal when the portable computer is in a vibration or shaking state.

14. The security method according to claim 13, wherein the step of producing the alarm signal further comprises:
detecting a force-exerted state of the portable computer and producing a detection signal accordingly; and
determining if the portable computer is in a vibration or shaking state according to the detection signal and producing the alarm signal if the portable computer is in a vibration or shaking state.

15. The security method according to claim 14, wherein the step of determining if the portable computer is in a vibration or shaking state further comprises:
triggering out a SCI signal to an operation system (OS) of the portable computer according to the detection signal;
transmitting the SCI signal to an application program (AP) of the portable computer by the OS; and
determining if the portable computer is in a vibration or shaking state according to the SCI signal by the AP, and producing the alarm signal if the portable computer is in a vibration or shaking state.

16. The security method according to claim 13, wherein the alarm signal comprises an alarm noise.

17. The security method according to claim 13, wherein the alarm signal comprises alarm information for informing the computer owner.

18. The security method according to claim 13, wherein the step of producing the alarm signal further comprises setting the portable computer in a screen-saver operation.
